(19) United States
(12) Patent Application Publication
(10) Pub. No.: US 2013/0209761 A1
(43) Pub. Date: Aug. 15, 2013

(54) AUTOMOTIVE PAINT SYSTEM FOR BRIGHT AND VIBRANT COLORS

(71) Applicant: James H. Bielak, Canton, MI (US)

(72) Inventor: James H. Bielak, Canton, MI (US)

(73) Assignee: FORD GLOBAL TECHNOLOGIES, LLC, DEARBORN, MI (US)

(21) Appl. No.: 13/371,557

(22) Filed: Feb. 13, 2012

(51) Int. Cl. B32B 9/04; B05D 5/06; B32B 7/02

(52) U.S. Cl. 428/212; 427/160

(57) ABSTRACT

A painted substrate forms at least a portion of an exterior body panel of a vehicle. A pre-treatment layer, and electrocoat layer, and a primer layer overlie the substrate. A colored, opaque basecoat layer overlies the primer layer and is comprised of polymeric resin and a first coloring agent. The basecoat layer is formulated to provide near ultraviolet light blocking. A colored, opaque topcoat layer overlies the basecoat layer and is comprised of polymeric resin and a second coloring agent having substantially the same color as the first coloring agent. The topcoat layer is formulated to provide a glossy appearance, chemical resistance, and scratch resistance. The topcoat layer is also formulated to provide ultraviolet blocking and paint-chip resistance greater than the ultraviolet blocking and paint-chip resistance of the basecoat layer.

### CROSS REFERENCE TO RELATED APPLICATIONS

Not Applicable.

### STATEMENT REGARDING FEDERALLY SPONSORED RESEARCH

### Not Applicable.

### BACKGROUND OF THE INVENTION

The present invention relates in general to painting of automotive and other vehicles, and, more specifically, to a multilayered paint system.

A conventional paint system for motor vehicles such as automobiles typically includes multiple layers wherein each layer is formulated to perform respective functions. In particular, a substrate such as a sheet metal body panel is first given a pre-treatment layer to provide corrosion resistance. Next, an electrocoat primer layer is applied that provides paint-chip resistance, corrosion resistance, and enhanced paint adhesion. A primer layer is applied over the electrocoat layer to give a smooth, uniform surface and to impart paint-chip resistance and ultraviolet light blocking (especially to protect the electrocoat layer which is very sensitive to ultraviolet light).

At the top of the paint system where the visible color is created, either a monocoat or a combined basecoat/clearcoat has been employed. A typical basecoat provides an identifiable color and near-ultraviolet light blocking. Over the basecoat, a clearcoat layer provides glossy appearance, ultraviolet light blocking, weathering durability, chemical resistance, scratch resistance, and other final properties including paint-chip resistance in order to ensure good paint performance and long-term stability. Alternatively, a monocoat final layer is sometimes used instead of the combined basecoat/clearcoat, wherein the monocoat layer combines the coloring performance of a normal basecoat with the environmental protection and durability formulations of a clearcoat. Although a basecoat formulation is in some respects similar to the formulation of a monocoat or clearcoat, the basecoat lacks modifications that provide broad-spectrum ultraviolet light blocking, chemical resistance, scratch resistance, or paint-chip resistance.

The conventional monocoat or basecoat layers are colored and substantially opaque, obtaining ultraviolet protection while providing visible hiding of the lower layers. This dependence on a single opaque layer has resulted in undesirable constraints on color performance. Specifically, the monocoat or basecoat has needed to be sufficiently dark in color and/or grey enough to obtain the required opacity, otherwise the lower layers would undesirably contribute to the surface appearance. Thus, very rich, monochromatic, vibrant, pure, and lighter colors have been difficult to obtain because they fail to provide the required opacity when applied in a single monocoat or basecoat layer.

### SUMMARY OF THE INVENTION

The present invention employs a colored and substantially opaque monocoat over a substantially opaque basecoat of the same or similar color to achieve the required environmental protection and opacity to lower layers while simultaneously achieving more rich, chromatic, vibrant, clean, and lighter colors.

In one aspect of the invention, a painted surface of a motor vehicle comprises a substrate forming at least a portion of an exterior body panel. A pre-treatment layer overlies the substrate and is formulated to provide corrosion resistance. An electrocoat layer overlies the pre-treatment layer and is formulated to provide paint-chip resistance and promote paint adhesion. A primer layer overlies the electrocoat layer and is formulated to provide a smooth surface, paint-chip resistance, and ultraviolet light blocking. A colored, opaque basecoat layer overlies the primer layer and is comprised of polymeric resin and a first coloring agent. The basecoat layer is formulated to provide near ultraviolet light blocking. A colored, opaque topcoat layer overlies the basecoat layer and is comprised of polymeric resin and a second coloring agent having substantially the same color as the first coloring agent. The topcoat layer is formulated to provide a glossy appearance, chemical resistance, and scratch resistance. The topcoat layer is also formulated to provide ultraviolet blocking and paint-chip resistance greater than the ultraviolet blocking and paint-chip resistance of the basecoat layer.

### BRIEF DESCRIPTION OF THE DRAWINGS

FIG. 1 is a cross section showing a conventional clearcoat system.

FIG. 2 is a cross section showing a conventional monocoat system.

FIG. 3 is a cross section showing a first embodiment of the paint system of the present invention.

FIG. 4 is a cross section showing a second embodiment of the paint system of the present invention.

### DETAILED DESCRIPTION OF PREFERRED EMBODIMENTS

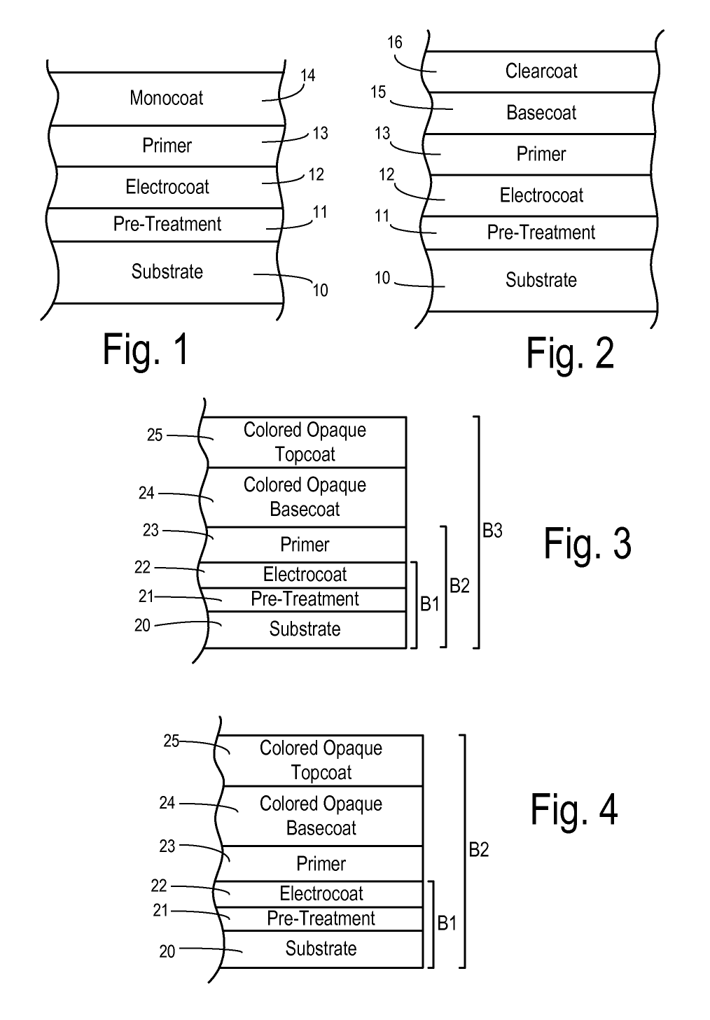

Multi-layer paint systems for automotive vehicles employ distinct types of layers or coats that are specially adapted to achieve desired performance levels. As shown in FIG. 1, a substrate 10 (which may be comprised of a conventional sheet metal body panel) receives a pre-treatment layer 11 to impart corrosion resistance. An electrocoat layer 12 overlies pre-treatment layer 11 to provide paint-chip resistance and to enhance paint adhesion. Electrocoat layer 12 may also be formulated to increase corrosion resistance. A primer layer 13 overlies electrocoat layer 12 and provides a smooth, uniform surface for receiving more overlying layers. Primer layer 13 is also typically formulated to improve chip resistance and to provide broad-spectrum ultraviolet light blocking because electrocoat layer 12 is very sensitive to and can break down in the presence of ultraviolet light.

One or more layers overlying primer layer 13 are sometimes generically referred to as the topcoat. A single layer known as a monocoat layer 14 is sometimes used. The monocoat layer 14 includes one or more coloring agents or pigments and possibly other texturing or light modifying ingredients to provide the desired color appearance and opaqueness. The formulation of monocoat layer 14 is also configured to provide a glossy appearance and other important topcoat functions such as broad-spectrum ultraviolet blocking, chemical resistance, and scratch and chip resistance.

Another known conventional paint system employs multiple coating layers over primer layer 13 as shown in FIG. 2. A basecoat layer 15 overlies primer layer 13 and has a main function of providing the desired color appearance and opaqueness. A separate clearcoat layer 16 overlying basecoat layer 15 is clear or may be slightly tinted, but is substantially transparent. Clearcoat layer 16 separately provides a glossy appearance as well as broad spectrum ultraviolet light blocking, weathering durability, and chip-resistance so the basecoat does not need to provide significant levels of these properties.

Conventional automotive paint systems have remained limited in their color presentation capabilities. The substantially opaque and colored monocoat or basecoat layers of the prior systems provided the opacity needed for visible hiding of the lower layers. The dependence on a single opaque layer constrains the color appearance that can be achieved. In other words, the monocoat or basecoat layer must be sufficiently dark and/or grey enough to protect the lower layers and provide the necessary opacity to hide the colors of the lower layers. In monocoat or basecoat formulations attempting to provide rich, chromatic, vibrant, clean, and lighter colors, it was not possible to provide the required opacity. Consequently, the color appearance would altered so that color contribution from lower layers prevented the intended lighter, vibrant colors from being achieved. The present invention combines simultaneous use of a colored and substantially opaque topcoat formulated as a monocoat and a substantially opaque basecoat, wherein the layers have the same or similar color so that sufficient opacity is obtained and rich, chromatic, vibrant, clean, and lighter colors are produced.

As shown in FIG. 3, a substrate 20 is coated with a pre-treatment layer 21, an electrocoat layer 22, and a primer layer 23. A first bake cycle B1 may be performed after applying electrocoat layer 22, and a second bake cycle B2 performed after applying primer layer 23. A colored, opaque basecoat layer 24 is applied over primer layer 23 with a formulation that provides near ultraviolet light blocking. Basecoat layer 24 may employ a known basecoat formulation such as one or more polymeric resins and at least a first coloring agent. In particular, a high solids basecoat common in the automotive industry such as one available from BASF Coatings, PPG Industries, or E. I du Pont de Nemours and Company may be employed.

A colored, opaque topcoat layer 25 is applied over basecoat layer 24 and is likewise comprised of at least one polymeric resin with at least a second coloring agent having substantially the same color as the first coloring agent. In particular, the coloring agents may be identical products. They are selected to provide substantially the same color spectrum and may typically be a lighter color and/or a more vibrant, monochromatic color than has been conventionally achievable. Topcoat layer 25 may employ conventional clearcoat ingredients or formulations to achieve a glossy appearance, chemical resistance, scratch and mar resistance, broad-spectrum ultraviolet light blocking, and paint-chip resistance. Thus, topcoat layer 25 may preferably correspond to a conventional clearcoat except that is has a greatly increased concentration of coloring agent so that topcoat layer 25 becomes completely opaque. For the formulation of topcoat layer 25 other than the coloring agent(s), the product known as Color Fuse available from BASF may be employed. In particular, the formulation of topcoat layer 25 provides ultraviolet blocking and paint-chip resistance greater than the ultraviolet blocking and paint-chip resistance of basecoat layer 24. After application of basecoat layer 24 and topcoat layer 25, a bake cycle B3 may be performed.

As shown in FIG. 4, a two-cycle baking process can alternatively be used wherein a first bake cycle B1 is performed after application of electrocoat layer 22, and a second bake cycle B2 is performed after application of primer layer 23, basecoat layer 24, and topcoat layer 25.

The basic formulations for basecoat layer 24 and topcoat layer 25 may preferably include polyurethane or other resins disbursed in water or other carriers together with pigmented coloring agents. Thickness of the layers conforms to the thicknesses of prior art basecoat and monocoat layers.

The present invention may be particularly adapted to achieve colors having a lightness greater than an “L” value of +95 (@ 15° measurement) and/or a chromaticity greater than a “C” value of +80 (@ 15° measurement), for example.

What is claimed is:

1. A painted surface of a motor vehicle comprising:
a substrate forming at least a portion of an exterior body panel;
a pre-treatment layer overlying the substrate formulated to provide corrosion resistance;
an electrocoat layer overlying the pre-treatment layer formulated to provide paint-chip resistance and promote paint adhesion;
a primer layer overlying the electrocoat layer formulated to provide a smooth surface, paint-chip resistance, and ultraviolet light blocking;
a colored, opaque basecoat layer overlying the primer layer comprised of polymeric resin and a first coloring agent, wherein the basecoat layer is formulated to provide near ultraviolet light blocking; and
a colored, opaque topcoat layer overlying the basecoat layer comprised of is polymeric resin and a second coloring agent having substantially the same color as the first coloring agent, wherein the topcoat layer is formulated to provide a glossy appearance, chemical resistance, and scratch resistance, and wherein the topcoat layer is formulated to provide ultraviolet blocking and paint-chip resistance greater than the ultraviolet blocking and paint-chip resistance of the basecoat layer.

2. A method of painting a surface of a substrate forming at least a portion of an exterior body panel of a motor vehicle, comprising the steps of:
applying a pre-treatment layer over the substrate formulated to provide corrosion resistance;
applying an electrocoat layer over the pre-treatment layer formulated to provide paint-chip resistance and promote paint adhesion;
applying a primer layer over the electrocoat layer formulated to provide a smooth surface, paint-chip resistance, and ultraviolet light blocking;
applying a colored, opaque basecoat layer over the primer layer comprised of polymeric resin and a first coloring agent, wherein the basecoat layer is formulated to provide near ultraviolet light blocking; and
applying a colored, opaque topcoat layer over the basecoat layer comprised of polymeric resin and a second coloring agent having substantially the same color as the first coloring agent, wherein the topcoat layer is formulated to provide a glossy appearance, chemical resistance, and scratch resistance, and wherein the topcoat layer is formulated to provide ultraviolet blocking and paint-chip resistance greater than the ultraviolet blocking and paint-chip resistance of the basecoat layer.
